(19) United States
(12) Patent Application Publication
(10) Pub. No.: US 2026/0028173 A1
(43) Pub. Date: Jan. 29, 2026

(54) FLUENT SOLID CONVEYING ASSEMBLY, CONVEYING COMPARTMENT, AND DISPENSING SYSTEM

(71) Applicant: Shenzhen Outao Industry Co., Ltd., Shenzhen (CN)

(72) Inventor: Feng Zhang, Shenzhen (CN)

(21) Appl. No.: 18/802,671

(22) Filed: Aug. 13, 2024

(30) Foreign Application Priority Data
Jul. 25, 2024 (CN) 202411014535.4

(51) Int. Cl. B65D 83/00; B65D 25/04

(52) U.S. Cl. CPC B65D 83/775; B65D 25/04

(57) ABSTRACT

A fluent solid conveying assembly, a conveying compartment, and a dispensing system. The fluent solid conveying assembly includes a first enclosure and a second enclosure. The first enclosure has a carrying surface, and the carrying surface defines an output port; the carrying surface and the second enclosure are enclosed to form a plurality of chambers that are mutually independent, and each of the plurality of chambers is configured to accommodate a fluent solid. The second enclosure is movably connected to the first enclosure: the second enclosure is restrictively mated with the first enclosure in a predetermined disassembly direction to follow the first enclosure to move in the disassembly direction; and the second enclosure is movably arranged along the carrying surface; during a movement of the second enclosure along the carrying surface, each of the plurality of chambers is capable of being in communication with the output port.

### CROSS REFERENCE TO RELATED APPLICATION

This application claims priority benefit of Chinese patent Application No. 202411014535.4, filed on Jul. 25, 2024, and the entire contents of which are incorporated herein by reference.

### TECHNICAL FIELD

The present disclosure relates to the field of fluent solid dispensing technologies, and more specifically to a fluent solid conveying assembly, a conveying compartment, and a dispensing system.

### BACKGROUND

In daily life, there are many scenarios that require the dispensing of fluent solid, such as dispensing pills to patients, sugar pills to children, and other scenarios that require the dispensing of fluent solid such as tablets and beads. Dispensing large quantities of fluent solid manually takes a great deal of time and effort and is therefore prone to dispensing errors and contamination of the fluent solid to be dispensed. Especially, when dispensing medication for the elderly or patients suffering from Alzheimer's disease, the health of the patients will be directly affected if the medication is dispensed incorrectly and contaminated.

Currently, there are a number of fluent solid dispensers on the market for conveniently dispensing fluent solid such as pills, which effectively minimize the occurrence of dispensing errors and contamination of the fluent solid such as pills. For example, Chinese Patent No. CN105109722A discloses a fully automatic drug dispensing and supplying system and an automatic separation method for solid drugs. The fully automatic drug dispensing and supply system has a drug loading cartridge and a drug supply cartridge for dispensing different types of drugs by separating the cartridge into multiple compartments. The base plates and the enclosing walls of the drug loading cartridge and the drug supply cartridge are of one-piece construction. The above two types of drug dispensers and the fluent solid dispensers currently on the market have a fluent solid separator cartridge with a one-piece structure of the base plate and the enclosing wall, which on the one hand is inconvenient to fill with fluent solid. On the other hand, when the number of compartments in the drug cartridge is too large, the size of individual compartments is relatively small, such that it is inconvenient to clean the cartridge, which, in the long term, is prone to breeding bacteria and affecting the user's health.

### SUMMARY OF THE DISCLOSURE

The main object of the present disclosure is to propose a fluent solid conveying assembly to solve the technical problems of inconvenient solid filling and inconvenient cleaning of the fluent solid separator box of a conventional fluent solid dispenser.

To solve the above problem, the present disclosure provides a fluent solid conveying assembly, including a first enclosure and a second enclosure;
wherein the first enclosure has a carrying surface, and the carrying surface defines an output port; the carrying surface and the second enclosure are enclosed to form a plurality of chambers that are mutually independent, and each of the plurality of chambers is configured to accommodate a fluent solid;
the second enclosure is movably connected to the first enclosure:
a) the second enclosure is restrictively mated with the first enclosure in a predetermined disassembly direction to follow the first enclosure to move in the disassembly direction; and
b) the second enclosure is movably arranged along the carrying surface; during a movement of the second enclosure along the carrying surface, each of the plurality of chambers is capable of being in communication with the output port.

In some embodiments, the second enclosure includes a spacer and a locking closure member fixedly connected to the spacer; the spacer is formed with a plurality of isolation grooves that are mutually independent, and the plurality of isolation grooves are mated with the carrying surface to form the plurality of chamber; the locking closure member is restrictively mated with the first enclosure in the disassembly direction, and the spacer is movable along the carrying surface.

In some embodiments, the second enclosure is rotatably mated with the first enclosure around the disassembly direction, and the locking closure member is restrictively mated with the first enclosure in a radial direction.

In some embodiments, the first enclosure is of a ring shape, and an inner edge of the first enclosure is disposed between the spacer and the locking closure member.

In some embodiments, the locking closure member includes a pressure plate and a retaining ring, the pressure plate being disposed opposite to the spacer, and the retaining ring being convexly disposed on a side of the pressure plate facing the spacer;
the first enclosure includes an annular carrying plate, and the carrying surface is formed on the carrying plate; the carrying plate is sleeved on a periphery of the retaining ring, and an inner edge of the carrying plate is disposed between the pressure plate and the spacer;
the pressure plate is restrictively mated with the carrying plate in the disassembly direction, and the retaining ring is restrictively mated with the carrying plate in the radial direction.

In some embodiments, the first enclosure further includes an inner ring rib, and the inner ring rib protrudes on a side of the inner edge of the carrying plate away from the spacer; the inner ring rib is enclosed with the inner edge of the carrying plate to form a concave portion, an outer edge of the pressure plate is disposed at the concave portion, and the outer edge of the pressure plate is restrictively mated with the inner ring rib in the radial direction.

In some embodiments, the first enclosure further includes an outer ring rib, and the outer ring rib protrudes on a side of an outer edge of the carrying plate away from the spacer.

In some embodiments, the first enclosure further includes a plurality of connecting ribs, the plurality of connecting ribs being spaced apart along a peripheral direction of the inner ring rib and connecting the inner ring rib and the outer ring rib.

In some embodiments, each chamber is opened on a side away from the first enclosure.

In some embodiments, the spacer includes an inner ring wall, an outer ring wall, and a plurality of scrapers; the outer ring wall is sleeved on a periphery of the inner ring wall, and the plurality of scrapers are spaced apart along a peripheral direction of the inner ring wall to separate an annular space between the inner ring wall and the outer ring wall to form the plurality of isolation grooves.

In some embodiments, the spacer further includes a connecting rib plate disposed on an inner peripheral surface of the inner ring wall, and the locking closure member is detachably fixed to the connecting rib plate.

In some embodiments, the connecting rib plate is arranged with a thickened portion, and the thickened portion defines a fixing hole on a side of the thickened portion proximate to the locking closure member; the locking closure member defines an overhang facing the fixing hole, and the fluent solid conveying assembly further includes a fastener that passes through the overhang and is detachably fixed to the fixing hole.

In some embodiments, the first enclosure is of a ring shape, and an outer peripheral surface of the first enclosure is arranged in alignment with an outer peripheral surface of the outer ring wall.

The present disclosure further provides a fluent solid conveying compartment, including a first housing and a fluent solid conveying assembly in any of the above embodiments; the first housing defines a transferring cavity opened along the disassembly direction of the fluent solid conveying assembly, and a transferring port is defined on an inner wall of the transferring cavity facing the output port of the fluent solid conveying assembly; the fluent solid conveying assembly is detachably arranged the transferring cavity in the disassembly direction.

In some embodiments, the first enclosure of the fluent solid conveying assembly is restrictively mated with the first housing along the carrying surface of the fluent solid conveying assembly.

In some embodiments, the first enclosure is restrictively mated with the first housing in a tangential direction around the disassembly direction.

In some embodiments, a bottom wall of the transferring cavity is arranged with a plurality of limit keys, and the first enclosure defines keyways that are adapted to the plurality of limit keys.

The present disclosure further provides a fluent solid dispensing system, including more than two the fluent solid conveying compartments in any of the above embodiments; wherein the more than two fluent solid conveying compartments are detachably stacked; in each two of the more than two fluent solid conveying compartments that are stacked adjacently, the transferring port of one of the two fluent solid conveying compartments is capable of being in communication with each chamber of the other of the two fluent solid conveying compartments and being aligned with the transferring port of the other of the two fluent solid conveying compartments.

In some embodiments, the fluent solid dispensing system further includes a control compartment and a drive mechanism; wherein the control compartment includes a second housing and a control board disposed in the second housing; the control compartment is arranged in a removable stack with one of the more than two fluent solid conveying compartments that is at an outermost end in a stacking direction; the drive mechanism includes a motor and a transmission unit connected to an output shaft of the motor, the motor being electrically connected to the control board, and the transmission unit being transmission-connected to the second enclosure of each fluent solid conveying compartment.

In some embodiments, the fluent solid dispensing system further includes a collection compartment; wherein the collection compartment includes a third housing and a drawer movably connected to the third housing; an inner cavity of the drawer is opened facing upward; the control compartment and the at least two fluent solid conveying compartments are detachably stacked in an up-down direction on an upper end of the collection compartment; the control compartment and the fluent solid conveying compartment at the outermost end are detachably stacked, and the transferring port of one of the at least two fluent solid conveying compartments that is adjacent to the collection compartment is disposed above the drawer.

In the fluent solid conveying assembly of the present disclosure, the first enclosure has a carrying surface, and the carrying surface defines an output port; the carrying surface and the second enclosure are enclosed to form multiple mutually independent chambers, and the chambers are configured to accommodate the fluent solid; the second enclosure is movable relative to the second enclosure in the disassembly direction; the second enclosure is restrictively mated with the first enclosure in a predetermined disassembly direction to follow the first enclosure to move in the disassembly direction; and the second enclosure is movably arranged along the carrying surface, and during the movement of the second enclosure along the carrying surface, each of the chambers is capable of being in communication with the output port. In this way, the first enclosure is both removable relative to the second enclosure and can be restrictively mated with the second enclosure in the disassembly direction. On the one hand, the first enclosure is detachable relative to the second enclosure, i.e., the bottom walls (carrying surface) forming the multiple chambers are detachable, and after the first enclosure is detached, the multiple chambers on the second enclosure are open toward the first enclosure, such that the chambers can be cleaned more thoroughly than the related art with the one-piece structure of the first and second enclosures, and sanitary dead corners can be avoided, which in turn effectively prevents the growth of bacteria due to the incomplete situation, thereby improving the reliability of the use of the fluent solid conveying assembly. On the other hand, the first enclosure and the second enclosure are restrictively mated with each other in the disassembly direction, such that the first enclosure and the second enclosure will not be loosened when they are relatively moving without affecting that the second enclosure is movable along the carrying surface of the first enclosure, and the two of them can be connected as a single whole for moving or dismantling, thereby facilitating loading of the fluent solid.

### BRIEF DESCRIPTION OF THE DRAWINGS

To illustrate the technical solutions of the embodiments of the present disclosure more clearly, the accompanying drawings of the embodiments will be briefly described below, and it will be apparent that the accompanying drawings in the following description relate only to some embodiments of the present disclosure and other drawings may be obtained from these drawings by those skilled in the art without creative labor.

FIG. 1 is a perspective structural schematic view of a fluent solid dispensing system according to some embodiments of the present disclosure.

FIG. 2 is an exploded structural schematic view of the fluent solid dispensing system in FIG. 1.

FIG. 3 is an exploded structural schematic view of a fluent solid conveying compartment in FIG. 1 at another viewing angle.

FIG. 4 is a front-side perspective structural schematic view of the fluent solid conveying compartment in FIG. 1.

FIG. 5 is a rear-side perspective structural schematic view of the fluent solid conveying compartment in FIG. 1.

FIG. 6 is another exploded structural schematic view of the fluent solid dispensing system in FIG. 1.

FIG. 7 is an exploded structural schematic view of a fluent solid conveying assembly in FIG. 6.

FIG. 8 is an exploded structural schematic view of the fluent solid conveying assembly in FIG. 6 at another viewing angle.

FIG. 9 is a cross-sectional structural schematic view of the fluent solid conveying assembly in FIG. 6.

FIG. 10 is a further exploded structural schematic view of the fluent solid conveying compartment in FIG. 1.

FIG. 11 is a perspective structural schematic view of a first housing in FIG. 10.

FIG. 12 is a partial enlarged view at A in FIG. 11.

FIG. 13 is a perspective structural schematic view of a transmission unit in FIG. 10.

FIG. 14 is a perspective structural schematic view of an assembly including a detection circuit board, a position sensor, and a first connector in FIG. 10.

FIG. 15 is a perspective structural schematic view of an assembly including a cover body, a bearing, and a second connector in FIG. 10 at another viewing angle.

FIG. 16 is a side-viewing cross-sectional structural schematic view of the fluent solid conveying compartment in FIG. 1.

FIG. 17 is a top-viewing cross-sectional structural schematic view of the fluent solid conveying compartment in FIG. 1.

FIG. 18 is a front-viewing cross-sectional structural schematic view of the fluent solid dispensing system in FIG. 1.

FIG. 19 is a cross-sectional structural schematic view along XIX-XIX in FIG. 18.

FIG. 20 is an exploded structural schematic view of the cross-sectional structure in FIG. 19.

### REFERENCE NUMERALS

| No. | Name | No. | Name | No. | Name |
|---|---|---|---|---|---|
| 100 | Fluent solid | 200 | Fluent solid | 10 | First housing |
| | dispensing system | | conveying | | |
| | | | compartment | | |
| 11 | Transferring | 12 | Core | 13 | Driving cavity |
| | cavity | | | | |
| 131 | Mounting port | 14 | Support plate | 141 | Second limit |
| | | | | | cylinder |
| 142a | First clamping | 142b | First clamping | 142c | First clamping |
| | plate | | plate | | plate |
| 142d | First clamping | 143 | First assembly hole | 15 | Support cylinder |
| | plate | | | | |
| 151 | Transmission hole | 152 | First bar | 153 | Second bar |
| 153a | Positioning slot | 154 | First step | 154a | First step surface |
| 154b | Second step | 155 | Second step | 155a | Third step surface |
| | surface | | | | |
| 155b | Fourth step | 156 | Guide slot | 157 | Clearance |
| | surface | | | | |
| 16 | Bottom frame | 161 | Transferring port | 162 | Limit key |
| 17 | Side frame | 20 | Drive mechanism | 21 | Motor |
| 22 | Transmission unit | 23 | Output gear | 24 | Marking ring |
| 241 | Light-transmitting | 25 | Center shaft | 26 | Bearing |
| | portion | | | | |
| 27 | Bushing | 28 | Input worm | 29 | Transmission worm |
| | | | | | gear |
| 30 | Fluent solid | 31 | First enclosure | 311 | Carrying plate |
| | conveying assembly | | | | |
| 312 | Carrying surface | 313 | Output port | 314 | Inner ring rib |
| 315 | Outer ring rib | 316 | Connecting rib | 317 | Keyway |
| 32 | Second enclosure | 33 | Spacer | 34 | Isolation groove |
| 35 | Hub | 351 | Connecting ring | 352 | Inner ring wall |
| 353 | Guide rail | 36 | Scraper | 37 | Outer ring wall |
| 38 | Connecting rib | 381 | Thickened portion | 382 | Fixing hole |
| | plate | | | | |
| 39 | Curved rack | 391 | Liner plate | 392 | Tooth portion |
| 393 | Mold exit | 40 | Locking closure | 41 | Pressure plate |
| | | | member | | |
| 42 | Retaining ring | 43 | Overhang | 45 | Chamber |
| 50 | Cover body | 51 | Cover plate | 511a | Second clamping |
| | | | | | plate |
| 511b | Second clamping | 511c | Second clamping | 512 | Second assembly |
| | plate | | plate | | hole |
| 52 | Blocking plate | 53 | Positioning | 54 | Pivot cylinder |
| | | | inserting plate | | |
| 55 | First limit | 56 | Partition plate | 561 | First splicing |
| | cylinder | | | | plate |
| 562 | Second splicing | 57 | Alignment cavity | 58 | Gear cavity |
| | plate | | | | |
| 60 | Position sensor | 62 | Light path slot | 63 | Detection circuit |
| | | | | | board |
| 64 | First electrical | 641 | First pin | 65 | Second electrical |
| | transmission | | | | transmission device |
| | device | | | | |
| 651 | Second pin | 300 | Fluent solid | 400 | Fluent solid |
| | | | transferring | | transferring |
| | | | assembly | | assembly |
| 500 | Collection | 70 | Third housing | 71 | Storage chamber |
| | compartment | | | | |
| 72 | Drawer | 73 | Collection Tank | 600 | Control compartment |
| 80 | Second housing | 81 | Mounting cavity | 82 | Control board |
| 83 | Key Switch | 84 | Battery | 85 | Display Panel |
| 86 | Physical key | | | | |

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained those skilled in the art without making creative labor fall within the scope of the present disclosure.

The present disclosure proposes a fluent solid conveying assembly, where a capacity chamber that holds the fluent solid can be dismantled and cleaned, in order to avoid the growth of bacteria that affects the health of the user due to incomplete cleaning of the capacity chamber.

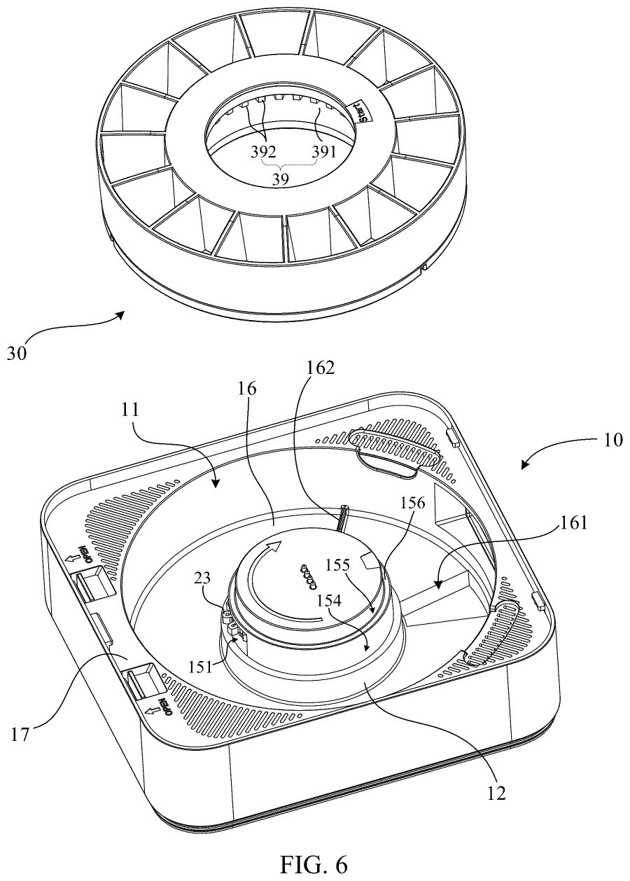

In some embodiments of the present disclosure, referring to FIGS. 6 to 8, 16, and 17, the fluent solid conveying assembly 30 includes a first enclosure 31 and a second enclosure 32;
the first enclosure 31 has a carrying surface 312, and the carrying surface 312 defines an output port 313; the carrying surface 312 and the second enclosure 32 are enclosed to form multiple mutually independent chambers 45, and the chambers 45 are configured to accommodate the fluent solid;
the second enclosure 32 is movably connected to the first enclosure 31:
a) the second enclosure 32 is restrictively mated with the first enclosure 31 in a predetermined disassembly direction to follow the first enclosure 31 to move in the disassembly direction; and
b) the second enclosure 32 is movably arranged along the carrying surface 312, and during the movement of the second enclosure 32 along the carrying surface 312, each of the chambers 45 is capable of being in communication with the output port 313.

In the embodiments, the multiple mutually independent chambers 45 are configured to place the fluent solid, and the number of chambers can be designed according to requirements. The multiple chambers are independent of each other, such that different kinds of fluent solids may be placed in different chambers. The size and shape of the multiple chambers may be the same or different, and typically the multiple chambers are with substantially the same size and shape for equal dispensing. The first enclosure 31 forms a base plate of a fluent solid separator box, and the second enclosure 32 forms a core of the fluent solid separator box. The carrying surface 312 of the first enclosure 31 and the second enclosure 32 are made to form multiple separate chambers 45, i.e., the carrying surface 312 forms bottom walls of the chambers. In other words, the N separate chambers 45 (excluding the bottom wall) formed on the second enclosure 32 are open on a side facing the first enclosure 31, and the first enclosure 31 is configured to sealingly cover the openings of the N−1 chambers 45 (excluding the bottom wall), such that the opening of the remaining one of the N chambers 45 is in communication with the output port 313 of the first enclosure 31. In this way, by adjusting the position of the first enclosure 31 relative to the second enclosure 32, the openings of different chambers 45 can be made to face the output port 313, thereby realizing the output of the fluent solids in the different chambers 45.

The multiple chambers 45 may be distributed in a circular shape, or in a straight line, etc., without specific limitation herein. The second enclosure 32 is movably connected to the first enclosure 31, where the two may be rotatably connected or slidably connected. The specific movable connection between the second enclosure 32 and the first enclosure 31 is required to be selected and designed according to the arrangement of the multiple chambers 45. For example, when the multiple chambers 45 are arranged in a circular shape, the second enclosure 32 is rotatable relative to the first enclosure 31 in the normal direction around the carrying surface 312 to realize switching different chambers 45 to be in communication with the output port 313. When the multiple chambers 45 are arranged in a straight line, the second enclosure 32 is slidably connected relative to the first enclosure 31 along the arrangement direction of the multiple chambers 45 to realize switching the different chambers 45 to be in communication with the output port 313. During the movement of the second enclosure 32 relative to the first enclosure 31 along the carrying surface 312, different chambers 45 are switched to be in communication with the output port 313, such that the fluent solid in the corresponding chamber 45 can be leaked out from the output port 313. When there is no need to convey the fluent solid, the connection between the chamber 45 and a transferring port 161 of a first housing 10 of the fluent solid conveying compartment 200 can be disconnected by the second enclosure 32, thereby realizing the sealing of the chamber 45.

It is noted that the second enclosure 32 being restrictively mated with the first enclosure 31 in the predetermined disassembly direction to follow the first enclosure 31 in the disassembly direction refers to that the first enclosure 31 is detachable relative to the second enclosure 32 in the predetermined direction. When not disassembled, the second enclosure 32 is restrictively mated with the first enclosure 31 in the predetermined disassembly direction, i.e., the first enclosure 31 cannot be disengaged from the second enclosure 32 in the disassembly direction. In this way, the second enclosure 32 can be translated or rotated relative to the first enclosure 31 along the carrying surface 312 while allowing the second enclosure 32 and the first enclosure 31 to be integrally movable in the disassembly direction. Specifically, the second enclosure 32 may be split into two components that are detachably connected in the predetermined disassembly direction, the first enclosure 31 is limited to be disposed between the two components in the disassembly direction, and the first enclosure 31 is rotatable or translatable relative to the two components of the second enclosure 32 along the carrying surface 312. In this way, the first enclosure 31 can be both detachable relative to the second enclosure 32 and restrictively mated with the second enclosure 32 in the disassembly direction.

In the fluent solid conveying assembly 30 of the present disclosure, the first enclosure 31 has a carrying surface 312, and the carrying surface 312 defines an output port 313; the carrying surface 312 and the second enclosure 32 are enclosed to form multiple mutually independent chambers 45, and the chambers 45 are configured to accommodate the fluent solid; the second enclosure 32 is movable relative to the second enclosure 32 in the disassembly direction; the second enclosure 32 is restrictively mated with the first enclosure 31 in a predetermined disassembly direction to follow the first enclosure 31 to move in the disassembly direction; and the second enclosure 32 is movably arranged along the carrying surface 312, and during the movement of the second enclosure 32 along the carrying surface 312, each of the chambers 45 is capable of being in communication with the output port 313. In this way, the first enclosure 31 is both removable relative to the second enclosure 32 and can be restrictively mated with the second enclosure 32 in the disassembly direction. On the one hand, the first enclosure 31 is detachable relative to the second enclosure 32, i.e., the bottom walls (carrying surface 312) forming the multiple chambers are detachable, and after the first enclosure 31 is detached, the multiple chambers on the second enclosure 32 are open toward the first enclosure 31, such that the chambers can be cleaned more thoroughly than the related art with the one-piece structure of the first and second enclosures 31, and sanitary dead corners can be avoided, which in turn effectively prevents the growth of bacteria due to the incomplete situation, thereby improving the reliability of the use of the fluent solid conveying assembly 30. On the other hand, the first enclosure 31 and the second enclosure 32 are restrictively mated with each other in the disassembly direction, such that the first enclosure 31 and the second enclosure 32 will not be loosened when they are relatively moving without affecting that the second enclosure 32 is movable along the carrying surface 312 of the first enclosure 31, and the two of them can be connected as a single whole for moving or dismantling, thereby facilitating loading of the fluent solid.

Further, the second enclosure 32 includes a spacer 33 and a locking closure member 40 fixedly connected to the spacer 33, optionally, the two are detachably connected. The spacer 33 is formed with multiple mutually independent isolation grooves 34, the isolation grooves 34 mating with the carrying surface 312 to form the multiple chamber 45. The locking closure member 40 is restrictively mated with the first enclosure 31 in the disassembly direction, and the spacer 33 is movable along the carrying surface 312.

In the embodiments, the locking closure member 40 is mainly configured to mate with the spacer 33 to restrictively fix the first enclosure 31 in the disassembly direction. Therefore, the structure of the locking closure member 40 may be adapted according to the specific structure of the spacer 33, and no specific limitation is made herein. The locking closure member 40 and the spacer 33 may be detachably connected by means of screws, snap-fit and the like. The first enclosure 31 is restrictively arranged between the locking closure member 40 and the spacer 33, and the locking closure member 40 is restrictively mated with the first enclosure 31 in the disassembly direction. In this way, the first enclosure 31 cannot be disengaged from the second enclosure 32 in the disassembly direction when the locking closure member 40 is fixed to the spacer 33. The multiple isolation grooves 34 formed on the spacer 33 are open on a side facing the carrying surface 312, and the carrying surface 312 is configured to cover the openings of the multiple isolation grooves 34 and to form the bottom walls of the chambers 45, so as to enable the isolation grooves 34 to mate with the carrying surface 312 to form the chambers 45. By causing the second enclosure 32 to include the locking closure member 40 and the spacer 33 that forms the multiple isolation grooves 34 independent of each other, i.e., dividing the second enclosure 32 into two components to jointly limit the first enclosure 31, where the component mainly used for limiting the first enclosure 31 is set as the locking closure member 40 and the component mainly used for forming the multiple independent chambers is set as the spacer 33, instead of dividing the multiple isolation grooves 34 into two halves, the wastage of material and space may be reduced, thereby making the entire structure of the second enclosure 32 more compact and occupying a smaller space. In other embodiments, it is possible to make the entire spacer 33 split into upper and lower halves, and the first enclosure 31 is sandwiched between the upper and lower halves of the spacer 33.

Further, each chamber 45 is open on a side away from the first enclosure 31. That is, the multiple isolation grooves 34 formed on the spacer 33 are open on both sides in the disassembly direction. In this way, it is more convenient to clean the multiple isolation grooves 34 on the spacer 33 to avoid sanitary dead corners. Moreover, the chamber 45 is open back from the first enclosure 31, which makes it more convenient for the storage or input of the fluent solid.

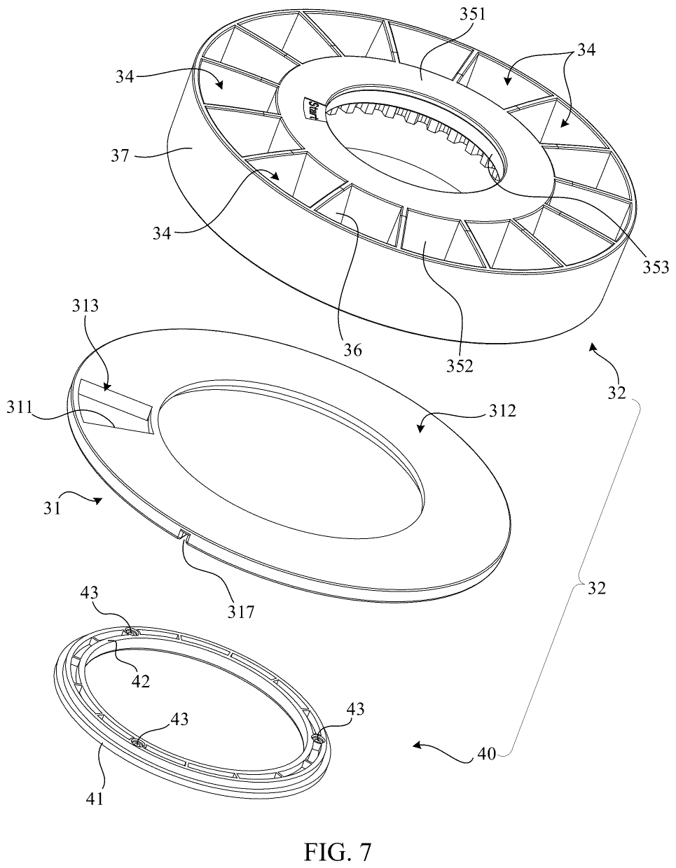

Further, referring to FIGS. 7 to 9 and 16, the second enclosure 32 is rotatably mated with the first enclosure 31 around the disassembly direction, and the locking closure member 40 is restrictively mated with the first enclosure 31 in a radial direction.

In the embodiments, the second enclosure 32 is rotatably mated with the first enclosure 31 around the disassembly direction, the multiple chambers 45 are arranged in a circular shape around the disassembly direction. In this way, by rotating the second enclosure 32 relative to the first enclosure 31, different chambers 45 can be switched to be in communication with the output port 313 of the first enclosure 31, thereby realizing the control of the output of the fluent solid in the corresponding chamber 45. It can be understood that the locking closure member 40 is arranged around the disassembly direction, such that the first enclosure 31 is limited between the locking closure member 40 and the spacer 33 in the disassembly direction when the first enclosure 31 is rotated.

Compared to the way in which the second enclosure 32 and the first enclosure 31 are slidingly coordinated, the rotational mating of the second enclosure 32 and the first enclosure 31 may effectively shorten the movement distance while precisely controlling the communication between the desired chamber 45 and the output port 313, so as to make the size distribution of the entire fluent solid conveying assembly 30 reasonable and the overall structure more compact. It is to be understood that the second enclosure 32 has a rotation axis which extends in a direction consistent with the disassembly direction, and the radial direction in the embodiments refers to a direction perpendicular to the rotation axis of the second enclosure 32. By making the locking closure member 40 restrictively mated with the first enclosure 31 in the radial direction, the first enclosure 31 may be effectively prevented from disengaging in the direction perpendicular to the rotation axis of the second enclosure 32 with respect to the second enclosure 32, thereby ensuring the rotational stability and reliability of the first enclosure 31 and the second enclosure 32.

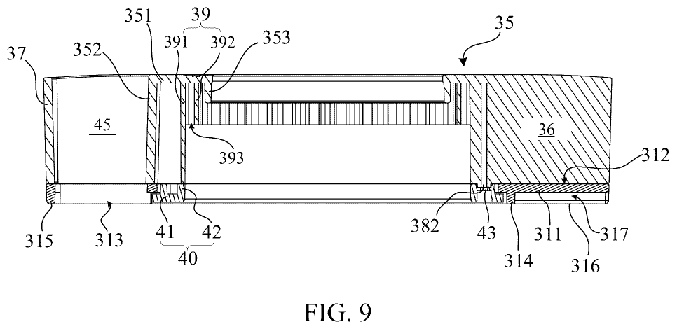

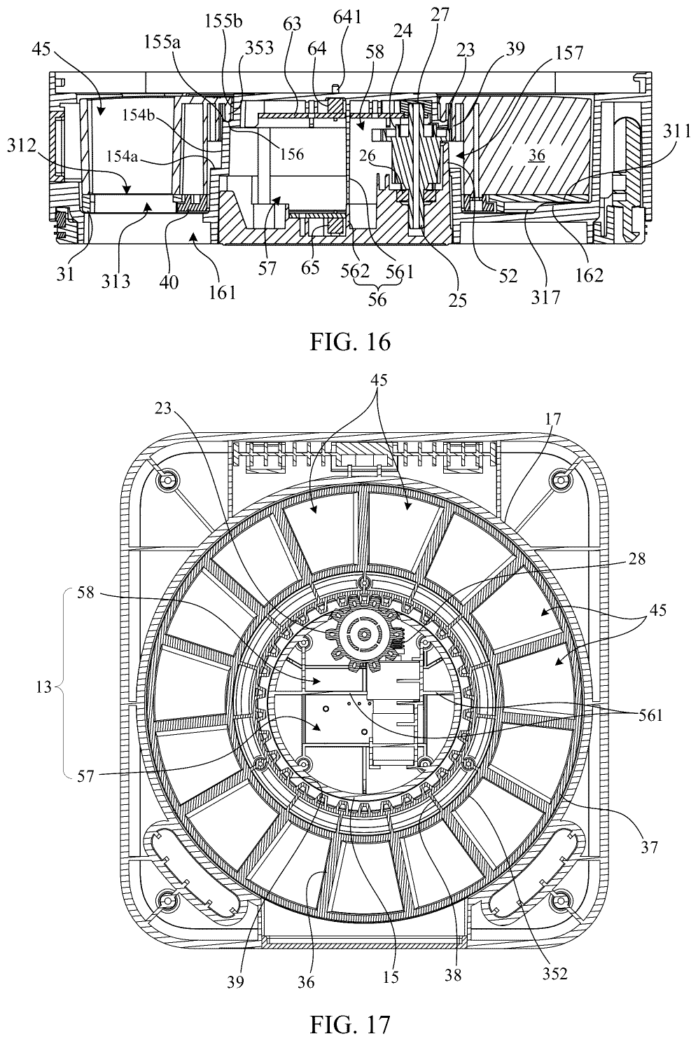

Further, as shown in FIGS. 9 and 16, the first enclosure 31 is in the shape of a ring, and an inner edge of the first enclosure 31 is disposed between the spacer 33 and the locking closure member 40. The inner edge of the first enclosure 31 is disposed between the spacer 33 and the locking closure member 40, such that the first enclosure 31 is disposed around the locking closure member 40. In this way, a restrictive mating between the first enclosure 31 and the locking closure member 40 in the radial direction may be realized, and the radial loosening of the first enclosure 31 with respect to the second enclosure 32 can be avoided without the need to provide an additional limit structure, and the structure of the locking closure member 40 and the first enclosure 31 may be simplified. Moreover, in order to simplify the assembly of the locking closure member 40 with the spacer 33, the locking closure member 40 may be arranged in a ring shape. Based on this, the locking closure member 40 may further include an annular limiting surface for the first enclosure 31, such that the first enclosure 31 can be limited by the limiting surface of the locking closure member 40 when rotating with respect to the second enclosure 32, thereby enhancing the rotational reliability and stability of the first enclosure 31 and the second enclosure 32.

The locking closure member 40 may be arranged in a ring-like structure, or it may include multiple arc-shaped bars spaced apart around the direction of the rotation axis of the first enclosure 31, which is not specifically limited herein.

Exemplarily, referring again to FIGS. 7 to 9, and FIG. 16, the locking closure member 40 includes a pressure plate 41 and a retaining ring 42, the pressure plate 41 being disposed opposite the spacer 33, and the retaining ring 42 being convexly disposed on a side of the pressure plate 41 facing the spacer 33;
the first enclosure 31 includes an annular carrying plate 311, and the carrying surface 312 is formed on the carrying plate 311; the carrying plate 311 is sleeved on a periphery of the retaining ring 42, and an inner edge of the carrying plate 311 is disposed between the pressure plate 41 and the spacer 33;
the pressure plate 41 is restrictively mated with the carrying plate 311 in the disassembly direction, and the retaining ring 42 is restrictively mated with the carrying plate 311 in the radial direction.

In the embodiments, specifically, the pressure plate 41 and the spacer 33 are disposed opposite and spaced apart in the extension direction of the rotation axis of the first enclosure 31. The carrying plate 311 is sleeved outside the retaining ring 42, and thus the carrying plate 311 is limited between the pressure plate 41 and the spacer 33. In this way, the first enclosure 31 can rotate around the outer periphery of the retaining ring 42, which may improve the smoothness and reliability of the rotation of the first enclosure 31 relative to the second enclosure 32. Moreover, due to the restrictive mating between the pressure plate 41 and the carrying plate 311 in the rotation axis, and the restrictive mating between the retaining ring 42 and the carrying plate 311 in the radial direction, the carrying plate 311 will not be disengaged from the retaining ring 42 during rotation. In this way, the pressure plate 41 and the retaining ring 42 of the locking closure member 40 are fully utilized to limit the first enclosure 31 in the axial and radial directions, so as to avoid the first enclosure 31 from detaching from the second enclosure 32 while ensuring the smooth rotation of the first enclosure 31 and the second enclosure 32; and the structure of the locking closure member 40 is simple and ingenious and the manufacturing cost is low.

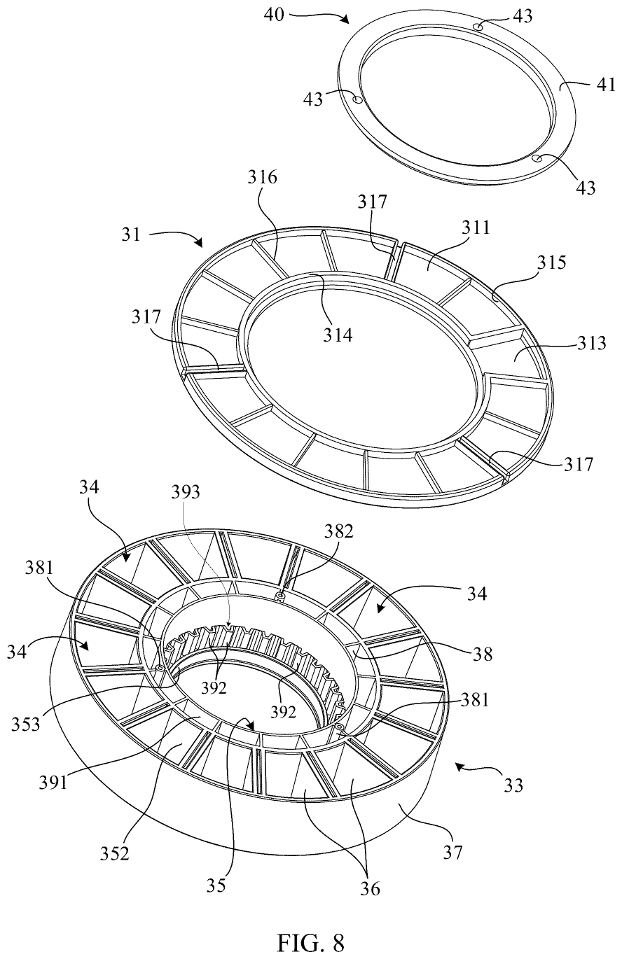

Further, as shown in FIGS. 8 and 9, the first enclosure 31 further includes an inner ring rib 314, and the inner ring rib 314 protrudes on a side of the inner edge of the carrying plate 311 that is back from the spacer 33. The inner ring rib 314 is enclosed with the inner edge of the carrying plate 311 to form a concave portion, the outer edge of the pressure plate 41 is disposed at the concave portion, and the outer edge of the pressure plate 41 is restrictively mated with the inner ring rib 314 in the radial direction. In this way, the retaining ring 42 of the locking closure member 40 and the inner edge of the carrying plate 311 form a restrictive mating structure that is hooked to each other, and the pressure plate 41 of the locking closure member 40 and the inner ring rib 314 of the first enclosure 31 form a restrictive mating structure that is hooked to each other, which may further enhance the effect of the restrictive mating between the first enclosure 31 and the second enclosure 32 in the radial direction. Through the restrictive mating between the inner ring rib 314 and the pressure plate 41 in the radial direction, the locking closure member 40 and the first enclosure 31 may be further prevented from being dislocated and disengaged in the radial direction. The inner ring rib 314 may be an entire ring or multiple curved convex bars extending and spaced apart along the peripheral direction.

Further, the first enclosure 31 further includes an outer ring rib 315, and the outer ring rib 315 protrudes on a side of the outer edge of the carrying plate 311 that is back from the spacer 33. By providing the outer ring rib 315, the flatness of the bottom surface of the first enclosure 31 may be ensured, which in turn ensures the smoothness of the mounting of the entire fluent solid output assembly. Specifically, the outer annular rib 315 and the inner annular rib 314 may have equal protruding heights.

Further, the first enclosure 31 further includes multiple connecting ribs 316, the multiple connecting ribs 316 being spaced apart along the peripheral direction of the inner ring rib 314 and connecting the inner ring rib 314 and the outer ring rib 315. Since the first enclosure 31 is disposed underneath the second enclosure 32 and is required to bear the entire weight of the second enclosure 32, the multiple connecting ribs 316 connecting the inner ring rib 314 and the outer ring rib 315 may ensure the structural strength of the first enclosure 31 and avoiding pressure damage.

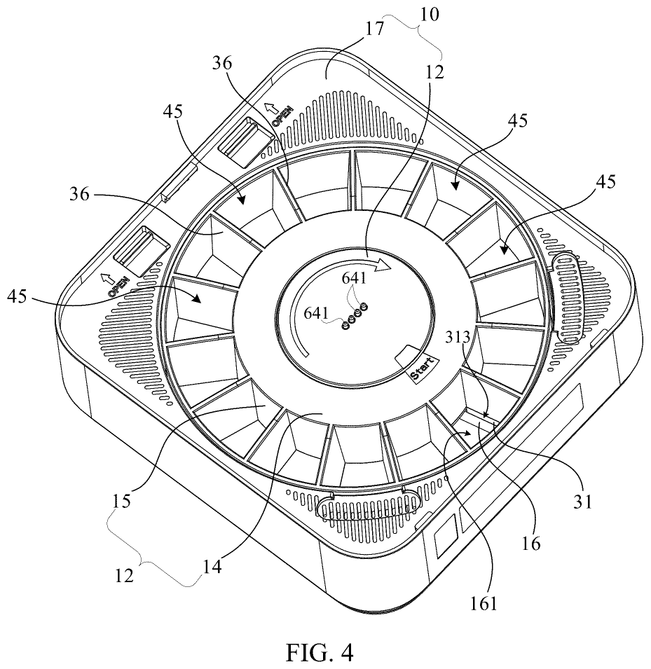

In combination with the above embodiments of the second enclosure 32 including the spacer 33 and the locking closure member 40, further with reference to FIGS. 4, 6 to 8, and 17, the spacer 33 includes an inner ring wall 352, an outer ring wall 37, and multiple scrapers 36, with the outer ring wall 37 sleeved on a periphery of the inner ring wall 352, and the multiple scrapers 36 spaced apart along a peripheral direction of the inner ring wall 352 to separate an annular space between the inner ring wall 352 and the outer ring wall 37 to form the multiple isolation grooves 34.

In the embodiments, the multiple isolation grooves 34 are arranged in an annular shape, which may effectively shorten the movement distance of the first enclosure 31 relative to the second enclosure 32, so as to make the size distribution of the entire fluent solid conveying assembly 30 reasonable and the overall structure more compact. The multiple scrapers 36 may be integrally molded with the inner ring wall 352 and the outer ring wall 37, or they may be separately molded and fixedly connected. The multiple scrapers 36 may be detachably connected with the inner ring wall 352 and the outer ring wall 37, or they may be non-detachably connected, of which is specifically not limited herein. An isolation groove 34 is formed between each two adjacent scrapers 36. The multiple isolation grooves 34 are arranged in an annular shape, such that the space in the middle of the inner ring wall 352 can be used to accommodate the rest of the structure of the fluent solid conveying compartment 200, for example, to accommodate a drive mechanism 20, thereby making the overall structure more compact and occupying less space. Moreover, the entire spacer 33 only consists of the inner ring wall 352, the outer ring wall 37, and the multiple scrapers 36, which has a simple structure and is easy to mold and manufacture. The inner ring wall 352, the outer ring wall 37, and the multiple scrapers 36 form a hub 35. The inner ring wall 352 extends along an axis, the inner periphery of the inner ring wall 352 is connected to a connecting ring 351 arranged in a radial direction, and the connecting ring 351 is configured to connect a liner plate 391 of a curved rack 39.

In some embodiments, as shown in FIG. 8, the spacer 33 further includes a connecting rib plate 38 disposed on an inner peripheral surface of the inner ring wall 352, and the locking closure member 40 is detachably fixed to the connecting rib plate 38. The connecting rib plate 38 may be provided as one or more than one, and where the connecting rib plate 38 is more than one, the multiple connecting rib plates 38 may be in a one-to-one correspondence with the multiple scrapers 36. By providing the connecting ribs 38 on the inner peripheral surface of the inner ring wall 352, the locking closure member 40 is detachably fixed to the connecting ribs 38, and the locking closure member 40 will not obscure and interfere with the isolation grooves 34, thereby avoiding the locking closure member 40 from affecting the conveying of the fluent solid. In order to minimize the interference of the locking closure member 40 with the fluent solid in the isolation grooves 34, the locking closure member 40 may be arranged on an inner side of the connecting rib plate 38 and/or the inner ring wall 352. The locking closure member 40 and the connecting rib plate 38 may specifically be detachably connected by means of screws, snaps, and the like.

Further, the connecting rib plate 38 is arranged with a thickened portion 381, and the thickened portion 381 defines a fixing hole 382 on a side of the thickened portion 381 proximate to the locking closure member 40; the locking closure member 40 defines an overhang 43 facing the fixing hole 382, and the fluent solid conveying assembly 30 further includes a fastener that passes through the overhang 43 and is detachably fixed to the fixing hole 382.

In the embodiments, the fastener may specifically be a screw, bolt, or the like. In some embodiments, the fastener is a screw in order to improve assembly efficiency. In this case, the fixing hole 382 may be a screw hole, and during assembly, the screw is threaded through the overhang 43 of the locking closure member 40 and threaded with the fixing hole 382 to realize a fixed connection between the locking closure member 40 and the spacer 33. The thickened portion 381 is arranged on the connecting rib plate 38, and the fixing hole 382 is defined on the thickened portion 381, which facilitates the dismantling and assembly of the locking closure member 40 and the spacer 33 without blocking and interfering the isolation groove 34.

In combination with the above embodiments of the spacer 33 including the outer ring wall 37, further referring to FIGS. 6, 9, and 10, the first enclosure 31 is in the shape of a ring, and an outer peripheral surface of the first enclosure 31 is arranged in alignment with an outer peripheral surface of the outer ring wall 37. The first enclosure 31 and the outer ring wall 37 may each be specifically a circular ring, such that the first enclosure 31 and the second enclosure 32 are cylindrical as a whole, which is more convenient to rotate and occupies less space. The outer peripheral surface of the first enclosure 31 and the outer peripheral surface of the outer ring wall 37 are set in alignment, which may avoid the assembly from being affected due to the formation of a step at the connection of the first enclosure 31 and the second enclosure 32, thereby ensuring the overall consistency of the appearance of the fluent solid conveying assembly 30.

Referring to FIGS. 4 to 10, the present disclosure further provides a fluent solid conveying compartment 200, including a first housing 10 and the fluent solid conveying assembly 30 referring to the above embodiments. The first housing 10 defines a transferring cavity 11 opened along the disassembly direction, and a transferring port 161 is defined on an inner wall of the transferring cavity 11 facing the output port 313; the fluent solid conveying assembly 30 is detachably arranged the transferring cavity 11 in the disassembly direction; since the fluent solid conveying compartment 200 is adopted with all the technical solutions in all the above embodiments, it has all the beneficial effects brought about by the technical solutions of the above embodiments, which will not be elaborated herein.

The shape of the first housing 10 may have many shapes, for example, the first housing 10 may be in the shape of a cube, a cylinder, etc., and the shape and size of the first housing 10 may be selected and designed according to usage requirements. There is no specific limitation on the shape and size of the first housing 10 herein. The first housing 10 is configured to arrange the fluent solid conveying assembly 30, and a drive mechanism 20 may further be arranged in the first housing 10 to drive the fluent solid conveying assembly 30 to move. The second enclosure 32 and the first enclosure 31 may be integrally removably arranged in the disassembly direction in the transferring cavity 11 to enhance assembly efficiency. During the movement of the second enclosure 32 relative to the first enclosure 31 along the carrying surface 312, different chambers 45 are switched to be in communication with the output port 313, such that the fluent solid in the corresponding chamber 45 flow out of the chamber 45 through the output port 313 and the transferring port 161 in turn. The first enclosure 31 may be fixed or movable relative to the first housing 10, and when the first enclosure 31 is movable relative to the first housing 10, the output port 313 of the second enclosure 32 may be moved to avoid the transferring port 161, such that the connection between the chamber 45 and the transferring port 161 can be disconnected by the second enclosure 32, thereby realizing the sealing of the chamber 45 and the blocking of the fluent solid from flowing out of the transferring port 161.

Specifically, the first housing 10 includes a core 12, a bottom frame 16, and a side frame 17; a driving cavity 13 is defined in the core 12; the bottom frame 16 extends radially outwardly from a bottom of the core 12; the side frame 17 extends upwardly from an outer edge of the bottom frame 16; the core 12, the bottom frame 16, and the side frame 17 enclose to form the transferring cavity 11, and the transferring port 161 is defined on the bottom frame 16.

In some embodiments, as shown in FIGS. 6 to 8, the first enclosure 31 is restrictively mated with the first housing 10 along the carrying surface 312. That is, the first enclosure 31 is not movable in the transferring cavity 11 along the extension direction of the carrying surface 312. In this way, by driving the second enclosure 32, the second enclosure 32 is caused to move relative to the first enclosure 31 and the first housing 10 for switching the connectivity of the different chambers 45 with the transferring port 161. No additional mechanism is required to control the movement of the first enclosure 31 relative to the first housing 10, which may simplify the structure of the entire fluent solid conveying compartment 200.

Further, the first enclosure 31 is restrictively mated with the first housing 10 in a tangential direction around the disassembly direction. That is, the first enclosure 31 may not rotate relative to the first housing 10 around the disassembly direction in the transferring cavity 11, thereby effectively avoiding the first enclosure 31 from rotating with the second enclosure 32.

Further, a bottom wall of the transferring cavity 11 is arranged with multiple limit keys 162, and the first enclosure 31 defines keyways 317 that are adapted to the limit keys 162. The number of the limit keys 162 may be designed according to actual requirements. In order to improve the solidity of the connection, the limit keys 162 may be provided with at least three, and the multiple limit keys 162 are spaced around the periphery of the transferring cavity 11. Through the mating of the limit keys 162 with the keyways 317, the fluent solid conveying assembly 30 may be easily disassembled and assembled as a whole from the transferring cavity 11, while realizing the peripheral limitation of the first enclosure 31 in the transferring cavity 11.

Further, the fluent solid conveying compartment 200 further includes a drive mechanism 20, where the first housing 10 includes a core 12, and the core 12 defines a driving cavity 13; the first enclosure 31 and the second enclosure 32 are each of an annular shape and rotatably disposed at the periphery of the driving cavity 13, and the multiple chambers 45 of the second enclosure 32 are disposed around the driving cavity 13; the drive mechanism 20 is disposed in the driving cavity 13, and the drive mechanism 20 includes a motor 21 and a transmission unit 22 connected to an output shaft of the motor 21; the second enclosure 32 is connected to the transmission unit 22 to rotate relative to the first housing 10 under the drive of the motor 21. By driving the second enclosure 32 to rotate by the drive mechanism 20, an automatic control of the dispensing of the fluent solid may be realized, thereby making the entire fluent solid dispensing system 100 more intelligent.

Further, the driving cavity 13 has a mounting port 131 disposed on the rotation axis of the second enclosure 32, and the mounting port 131 is configured for the drive mechanism 20 to be arranged into the driving cavity 13. The driving cavity 13 has the mounting port 131 disposed on the rotation axis of the spacer 33, such that the drive mechanism 20 may be arranged in the driving cavity 13 of the first housing 10 in the extension direction of the rotation axis of the second enclosure 32. Compared with other assembly methods, the proposed design in the present disclosure makes the disassembly and maintenance of the drive mechanism 20 more convenient and quicker.

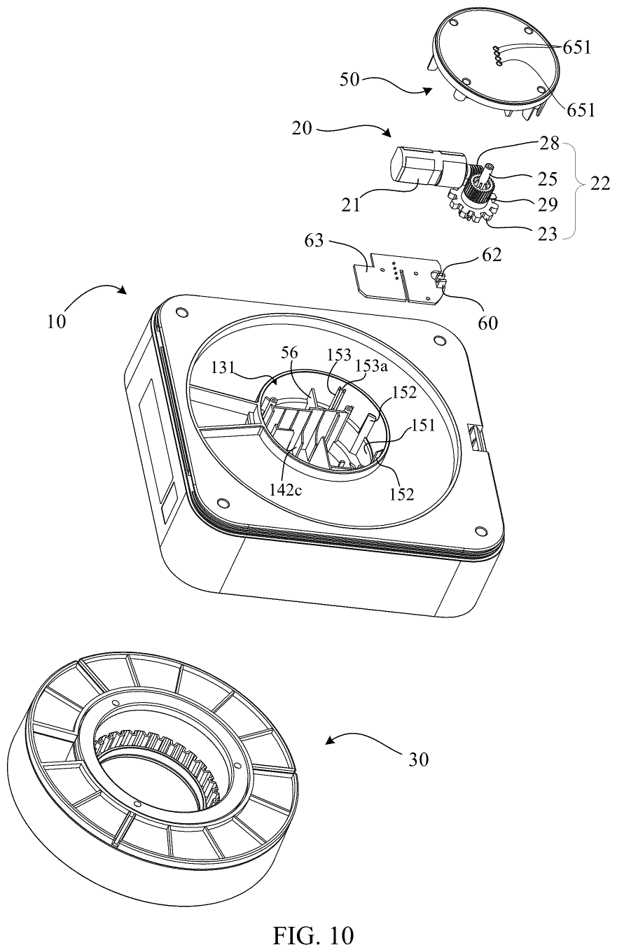

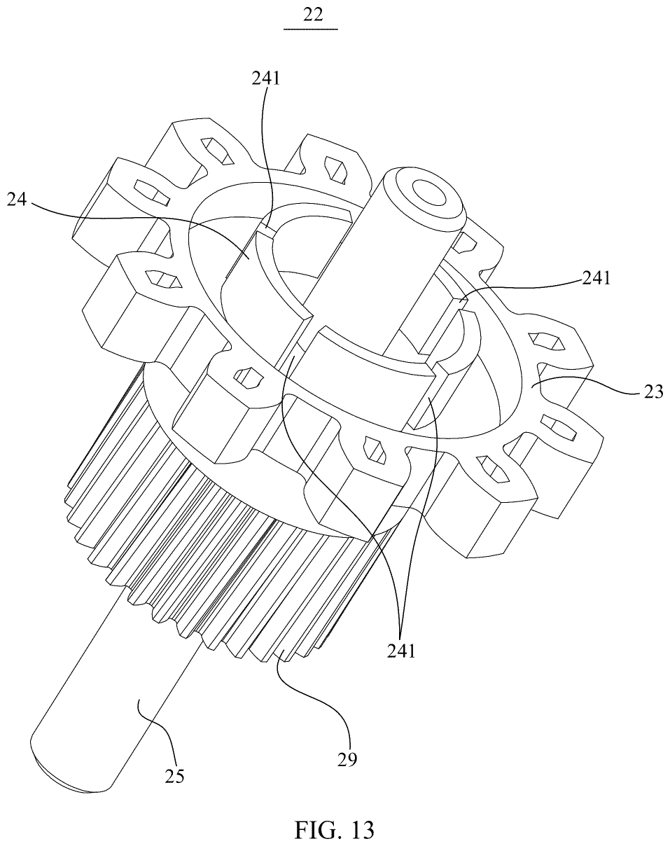

Further, referring to FIG. 10, FIG. 13, FIG. 16 and FIG. 17, the transmission unit 22 further includes an input worm 28 and a transmission worm gear 29 meshing with the input worm 28. The input worm 28 is fixedly connected to the output shaft of the motor 21, the transmission worm gear 29 is coaxial with an output gear 23, and an outer diameter of the transmission worm gear 29 is less than an outer diameter of the output gear 23; a transmission hole 151 is defined on a side wall of the driving cavity 13; a side wall of the second enclosure 32 adjacent to the driving cavity 13 is arranged with a curved rack 39, and the output gear 23 meshes with the curved rack 39 through the transmission hole 151. The motor 21 is made to realize deceleration through a worm-gear mechanism, which simplifies the deceleration mechanism and makes the structure compact, and further, the transmission is smoother and less noisy.

Further, with reference to FIG. 16, a clearance 157 is defined between a side of the transmission hole 151 near the mounting port 131 and the output gear 23. In this way, the output gear 23 may be prevented from contacting with the side wall of the transmission hole 151 and jamming or generating friction noise. In addition, the transmission hole 151 is set to be larger, which makes it easier for the output gear 23 to be assembled to the transmission hole 151 through the mounting port 11, reduces the difficulty of aligning the output gear 23 with the curved rack 39.

Further, the fluent solid conveying compartment 200 further includes a cover body 50. The cover body 50 includes a cover plate 51 and a blocking plate 52 disposed on an inner side of the cover plate 51. The cover plate 51 covers the mounting port 131, and the blocking plate 52 shields the clearance 157, which ensures the isolation effect of the drive chamber 13 and effectively avoids the entry of impurities, such as powder and dust, into the motor 21 from the clearance 157.

Further, with reference to FIGS. 10 to 12, an inner wall surface of the driving cavity 13 is arranged with two opposing first bars 152, and the two first bars 152 extend along the rotation axis of the second enclosure 32 and are disposed on both sides of the transmission hole 151 along the rotation direction of the spacer 33; the blocking plate 52 is positionally mated with the first bars 152. In this way, the first bars 152 on both sides of the transmission hole 151 have a positioning and guiding effect on the blocking plate 52.

Further, the inner wall surface of the driving cavity 13 is further arranged with multiple second bars 153 extending along the rotation axis of the second enclosure 32. Each second bar 153 defines a positioning slot 153a extending along the rotation axis of the second enclosure 32. The multiple first bars 152 and the multiple second bars 153 are arranged at intervals along the rotation direction of the spacer 33. Multiple positioning inserting plates 53 are arranged on an inner side of the cover plate 51 adapted to the positioning slots 153a. In this way, the mounting precision of the cover body 50 and the driving cavity 13 may be improved. In addition, the assembly between the cover body 50 and the inner wall of the driving cavity 13 may be more stable and reliable, thereby effectively preventing the two from accidentally coming loose.

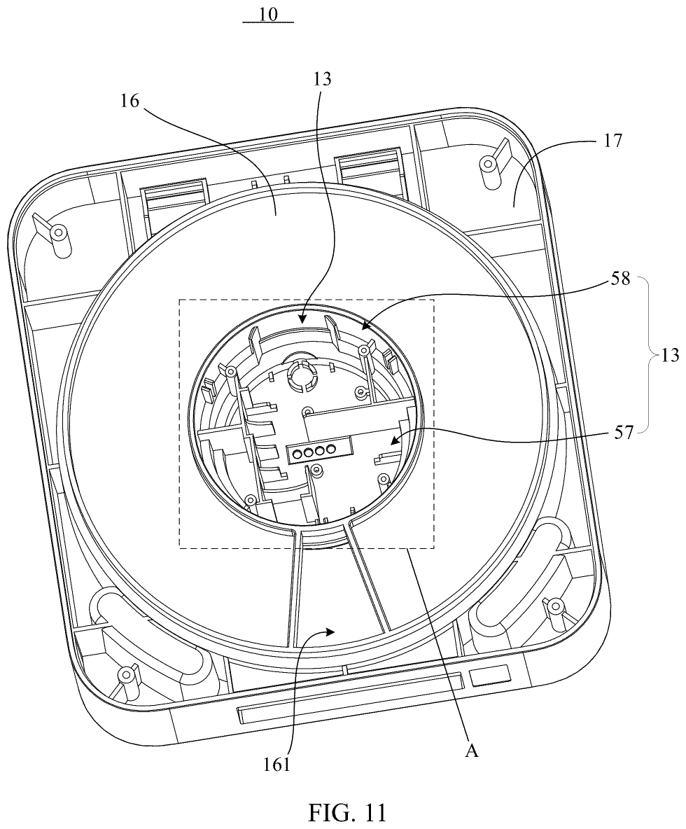

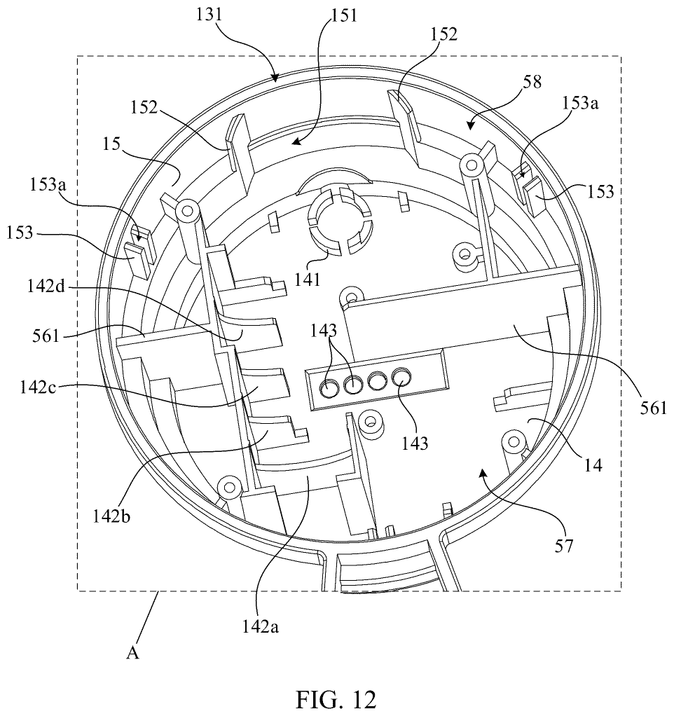

Further, as shown in FIG. 6, FIG. 11, FIG. 12, and FIG. 16, the first housing 10 includes a support plate 14 and a support cylinder 15 that are connected to each other and enclose to form the driving cavity 13. The support plate 14 is disposed opposite to the mounting port 131. The fluent solid conveying compartment 200 further includes a cover body 50, which includes a cover plate 51 that covers and closes the mounting port 131. The transmission unit 22 further includes a center shaft 25 connected to the output gear 23, and two ends of the center shaft 25 are connected to the support plate 14 and the cover plate 51, respectively.

Making full use of the support plate 14 and the cover plate 51 to connect the two ends of the center shaft 25 of the transmission unit 22 may effectively reduce the occupancy height of the center shaft 25 in the driving cavity 13, thereby making the overall structure more compact, and thus effectively reducing the height of the entire fluent solid conveying compartment 200, which is conducive to the realization of the miniaturization of the entire machine. Moreover, there is no need to additionally arrange other mounting structures to mount the center shaft 25, which may simplify the assembly structure in the driving cavity 13.

Further, as shown in FIG. 16, the output gear 23 is fixedly connected to the center shaft 25, and the transmission unit 22 further includes a bearing 26 and a bushing 27 respectively arranged on both ends of the center shaft 25. An outer ring of the bearing 26 is fixedly connected to the cover plate 51, and the bushing 27 is fixedly connected to the support plate 14. The rigidity of the bushing 27 is greater than the rigidity of the material of the support plate 14. The center shaft 25 is rotatably mated with the bushing 27. Specifically, the first housing 10 includes a second limit cylinder 141 integrally molded with the support plate 14, the material of the second limit cylinder 141 is the same as the material of the support plate 14, and the bushing 27 is peripherally limited and embedded in an inner cavity of the second limit cylinder 141. In this way, the manufacturing cost may be reduced by saving the number of bearings 26.

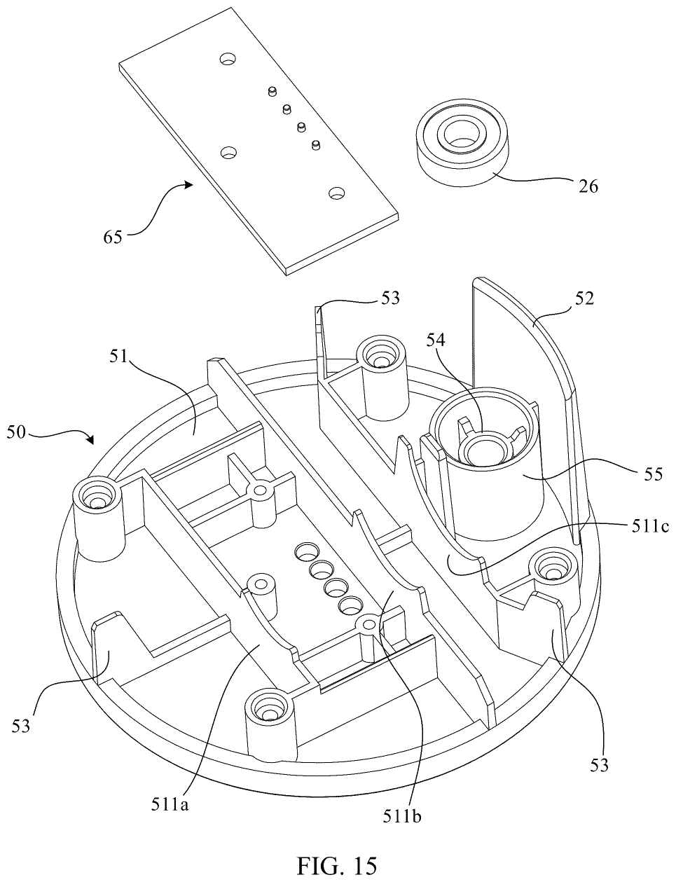

Specifically, referring to FIGS. 15 and 16, the cover body 50 includes a pivot cylinder 54 and a first limit cylinder 55 protruding on an inner side of the cover plate 51. The first limit cylinder 55 is disposed on the periphery of the pivot cylinder 54, the outer ring of the bearing 26 is fixedly embedded in the first limit cylinder 55, and the center shaft 25 is rotatably mated with an inner wall surface of the pivot cylinder 54. By setting the pivot cylinder 54 to mount the center shaft 25 and setting the first limit cylinder 55 to fix the bearing 26, the mounting of the bearing 26 is more stable and reliable, which in turn makes the rotation of the center shaft 25 more smooth and reliable.

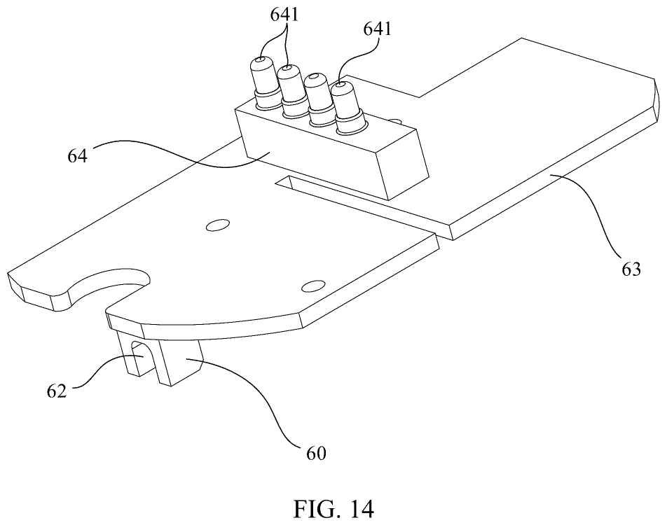

Further, as shown in FIGS. 10 and 14, the fluent solid conveying compartment 200 further includes a position sensor 60. The position sensor 60 is arranged adjacent to the output gear 23 and is configured to detect the rotation angle of the output gear 23. The position sensor 60 may specifically be embedded in a central cavity of the output gear 23 for precise detection. By providing the position sensor 60, the rotation angle and position of the output gear 23 can be accurately detected, and rotation counting can further be realized, which in turn facilitates intelligent control of the rotation angle and the number of rotations of the spacer 33. There may be many types of the position sensor 60, for example, the position sensor 60 may be a laser displacement sensor, a Hall sensor, etc., and the specific type of the position sensor 60 is not limited herein, as long as it can realize accurate detection of the rotation angle of the output gear 23.

Further, the fluent solid conveying compartment 200 further includes a detection circuit board 63 fixedly disposed on an inner side of the support plate 14, and the detection circuit board 63 is disposed opposite to the output gear 23;
the position sensor 60 is electrically connected to the detection circuit board 63 and fixed to a side of the detection circuit board 63 facing the output gear 23, and an end of the position sensor 60 away from the detection circuit board 63 defines a light path slot 62;
a side of the output gear 23 facing the detection circuit board 63 is arranged with a marking ring 24 protruding from the side of the output gear 23, and the marking ring 24 is disposed in the light path slot 62 and arranged with multiple light-transmitting portions 241 along the rotation direction of the output gear 23. The light-transmitting portion 241 may be a slot or a light-transmitting solid part.

In this way, accurate detection of the rotation angle and position of the output gear 23 may be realized, which in turn improves the rotation control precision of the second enclosure 32, thereby improving the precision of dispensing of the fluent solid in the fluent solid conveying compartment 200, so as to reduce the probability of dispensing errors.

Further, referring again to FIGS. 10 to 12 and 15, the first housing 10 further includes multiple first clamping plates 142a, 142b, 142c, 142d disposed on the inner side of the support plate 14, and the cover body 50 further includes multiple second clamping plates 511a, 511b, 511c disposed on the inner side of the cover plate 51. The multiple first clamping plates 142a, 142b, 142c, 142d and the multiple second clamping plates 511a, 511b, 511c are spaced apart along the rotation axis of the output shaft of the motor 21. The first clamping plates 142a, 142b, 142c, 142d and the second clamping plates 511a, 511b, 511c clamp the motor 21 and all have curved edges adapted to the outer periphery of the motor 21.

In this way, it is ensured that the entire motor 21 is uniformly clamped and fixed, and the solidity of the connection between the motor 21 and the first housing 10 and the cover body 50 is enhanced. In addition, by providing the multiple spaced-apart first clamping plates 142a, 142b, 142c, 142d and second clamping plates 511a, 511b, 511c, while ensuring that the motor 21 is mounted firmly, the height difference between the motor 21 and the output gear 23 may be shortened, thereby shortening the power transmission path.

Further, as shown in FIGS. 10 and 12, the fluent solid conveying compartment 200 further includes a partition plate 56 extending between the support plate 14 and the mounting port 131. The partition plate 56 separates the driving cavity 13 into an alignment cavity 57 and a gear cavity 58. The motor 21 is disposed through the partition plate 56, with a lead end of the motor 21 disposed in the alignment cavity 57, and the output gear 23 and the output shaft of the motor 21 disposed in the gear cavity 58.

The driving cavity 13 is longitudinally separated into the alignment cavity 57 and the gear cavity 58 by the partition plate 56 to partition the function of the driving cavity 13. In this way, the electrically-connected structure and the mechanically-driven structure within the driving cavity 13 are separated, thereby effectively avoiding interference between the electrically-connected wires and the output shaft, the output gear 23, and other drive structures.

Specifically, in order to facilitate injection molding, as shown in FIG. 12, the partition plate 56 includes a first splicing plate 561 and a second splicing plate 562 spliced with the first splicing plate 561. The first splicing plate 561 is integrally molded (in a one-piece structure) with the support plate 14 and the support cylinder 15, and the second splicing plate 562 is integrally molded with the cover plate 51. The extended height of the first splicing plate 561 is greater than the extended height of the second splicing plate 562. In this way, the difficulty of extracting the mold of the first housing 10, which is dominated by the inner cavity structure, may be relatively reduced.

Further, a first step 154 is arranged at a connection between an outer peripheral surface of the support cylinder 15 and an outer side surface of the support plate 14. The first step 154 includes a first step surface 154a extending in the radial direction and a second step surface 154b extending in the axial direction. The transmission hole 151 is disposed in the second step surface 154b, and the curved rack 39 is disposed in a concave cavity of the first step 154. While ensuring that the curved rack 39 meshes with the output gear, the gap between the outer wall surface of the support cylinder 15 and the inner peripheral wall of the spacer 33 is minimized, which in turn results in a smaller gap between the spacer 33 and the driving cavity 13, and thus a more compact overall structure is realized.

Further, a second step 155 is arranged at a connection between the second step surface 154b and the outer side surface of the support plate 14. The second step 155 includes a third step surface 155a extending in the radial direction and a fourth step surface 155b extending in the axial direction. One of the third step surface 155a and the inner edge of the spacer 33 defines a guide grooves 156, the other is arranged with a guide rail 353, and the guide rail 353 is rotatably mated with the guide groove 156. In this way, the rotation accuracy of the spacer 33 with respect to the driving cavity 13 may be improved to avoid the spacer 33 shifting and jamming.

Further, as shown in FIGS. 8 and 9, the curved rack 39 includes a liner plate 391 and multiple tooth portions 392 fixed on the liner plate 391. The tooth portion 392 is hollow and has a mold exit 393 near the output gear 23, and the output gear 23 can be meshed with the hollow tooth portions 392 of the curved rack 39 through the mold exits 393, thus making the output gear 23 and the curved rack 39 deep meshing, which may enhance the accuracy of rotation of the spacer 33 relative to the driving cavity 13. In this way, the output gear 23 and the curved rack 39 are deeply meshed, which may improve the transmission reliability and stability of the two.

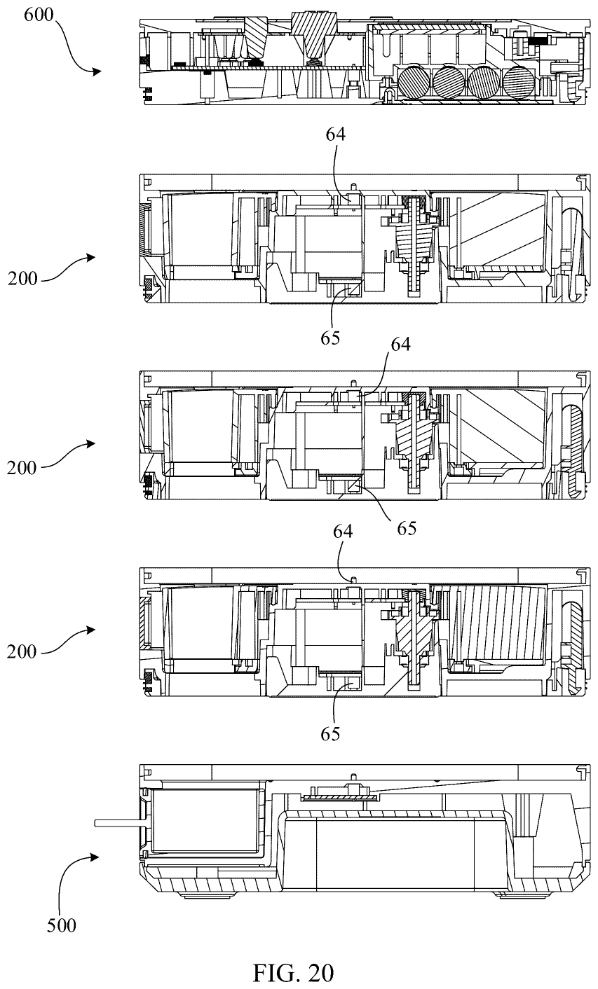

Further, as shown in FIG. 4, FIG. 6, FIG. 14, FIG. 16, and FIG. 20, the first housing 10 includes a support plate 14 and a support cylinder 15 that are connected to each other and enclose to form the driving cavity 13, with the support plate 14 being connected to an end of the support cylinder 15. The fluent solid conveying capsule 200 further includes a first electrical transmission device 64 disposed on the support plate 14. The first electrical transmission device 64 includes multiple first pins 641, and the support plate 14 defines multiple first assembly holes 143 for the first pins 641 to be exposed.

By providing the first electrical transmission device 64 on the support plate 14, the entire fluent solid conveying compartment 200 may be electrically connected to other structures, such as another fluent solid conveying compartment 200, which improves the ease of electrical connection of the entire fluent solid dispenser 100. Moreover, when there are multiple fluent solid conveying compartments 200, two adjacent fluent solid conveying compartments 200 are electrically connected through the first electrical transmission device 64, such that only one control unit is required to be set up to synchronize the control of the motors 21 of the multiple fluent solid conveying compartments 200, which may effectively simplify the structure of the whole machine and reduce the cost of the whole machine.

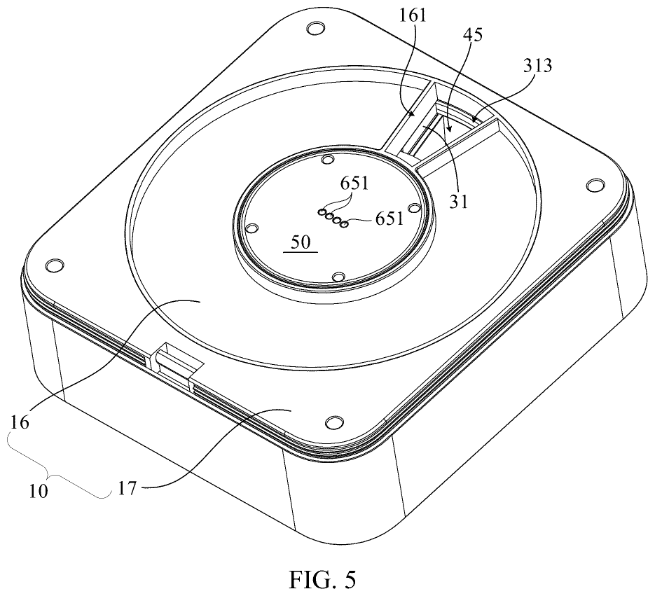

Further, referring again to FIGS. 5, 10, 16, and 20, an end of the support cylinder 15 away from the support plate 14 is formed with a mounting port 131, and the mounting port 131 is configured for the transmission unit 22 to be mounted into the driving cavity 13. The fluent solid conveying compartment 200 further includes a cover body 50 and a second electrical transmission device 65. The cover body 50 includes a cover plate 51 that covers the mounting port 131, and the second electrical transmission device 65 is arranged on the cover plate 51. The second electrical transmission device 65 includes multiple second pins 651, and the cover plate 51 defines multiple second assembly holes 512 for the second pins 651 to be exposed.

The second electrical transmission device 65 is arranged on the cover plate 51, i.e., the entire first housing 10 has electrical transmission devices on both the upper and lower sides. Therefore, both the upper and lower sides of the first housing 10 can be electrically connected to external structures through the electrical transmission devices, which may greatly reduce the difficulty of electrical connection and improve the assembly efficiency. When there are three fluent solid conveying compartments 200 to be arranged, the middle fluent solid conveying compartment 200 can be electrically connected to the upper and lower fluent solid conveying compartments 200 through the first electrical transmission device 64 and the second electrical transmission device 65, respectively, such that the motors 21 of the multiple fluent solid conveying compartments 200 can be synchronously controlled with only one power supply, thereby effectively simplifying the structure of the whole machine and reducing the cost of the whole machine.

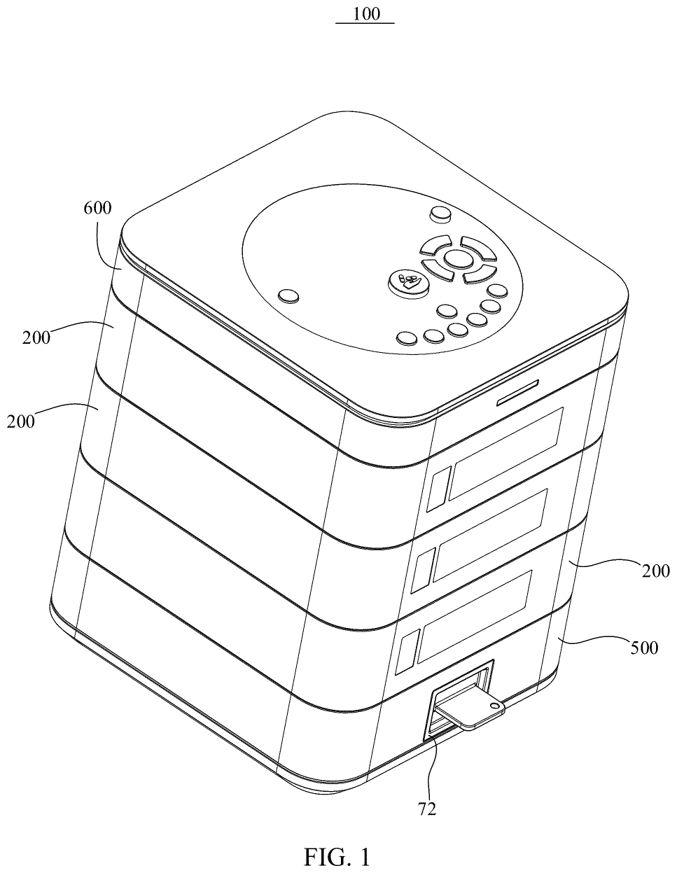

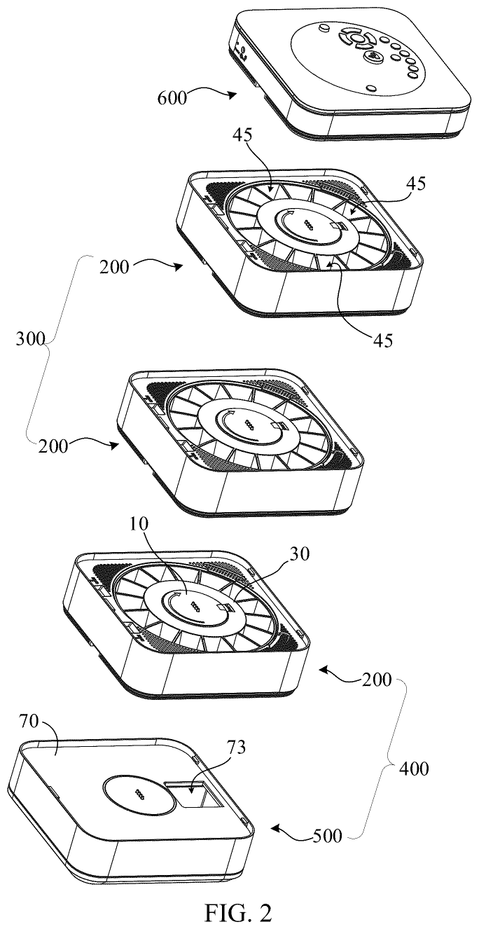

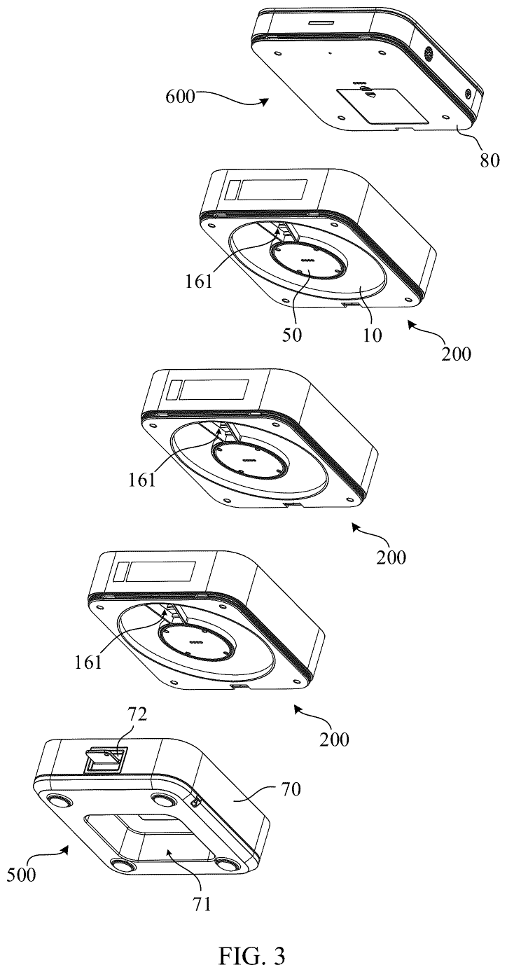

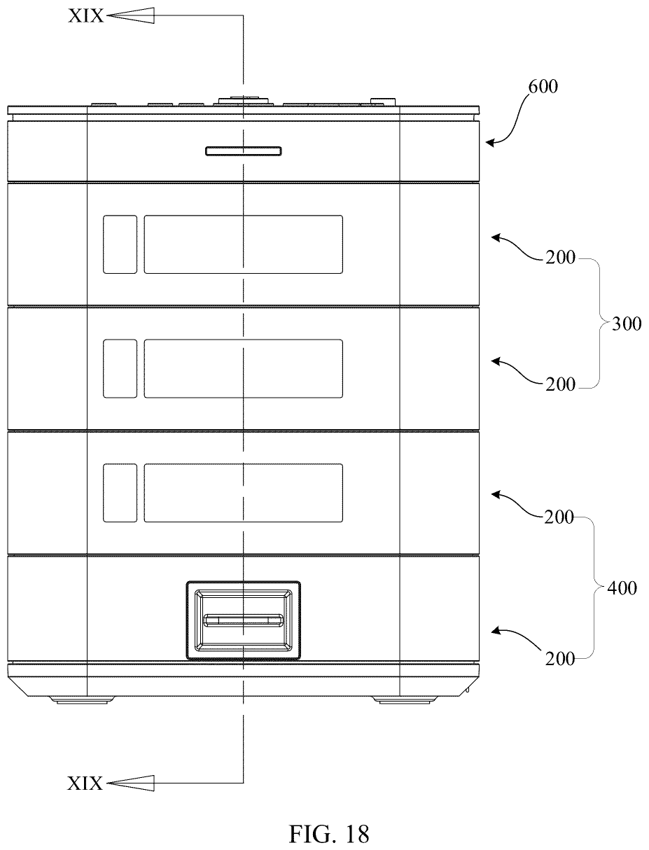

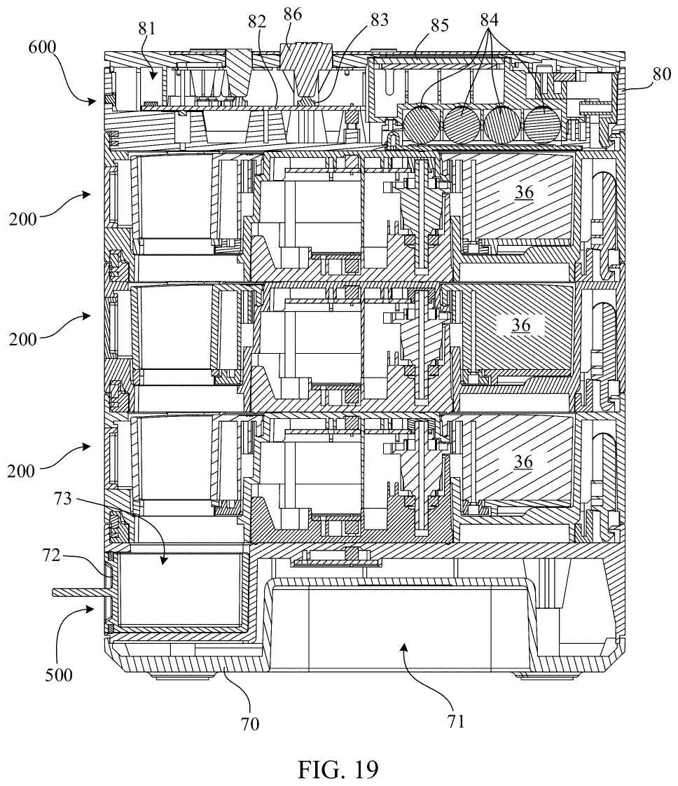

Referring to FIGS. 1 to 3, and FIGS. 18 to 20, the present disclosure further provides a fluent solid dispensing system 100, including more than two the fluent solid conveying compartments 200 each referring to the above embodiments. The fluent solid conveying compartments 200 are detachably stacked, and in each two fluent solid conveying compartments 200 that are stacked adjacently, the transferring port 161 of one of the two fluent solid conveying compartments 200 is capable of being in communication with each chamber 45 of the other fluent solid conveying compartment 200 and aligned with the transferring port 161 of this fluent solid conveying compartment 200. Since the fluent solid dispensing system 100 is adopted all the technical solutions in all the above embodiments, it has all the beneficial effects brought about by the technical solutions of the above embodiments, which will not be elaborated herein.

The multiple fluent solid conveying compartments 200 are combined to form the fluent solid transferring assembly 300. By making the fluent solid dispensing system 100 include multiple fluent solid conveying compartments 200, and making the multiple fluent solid conveying compartments 200 capable of being disassembled and stacked and fitted together as a single unit, the number of the fluent solid conveying compartments 200 required to be stacked can be selected according to usage requirements, and the limit of the number of chambers 45 provided for holding the fluent solid in a single fluent solid conveying compartment 200 is exceeded, so as to meet the need for dispensing more different types and quantities of fluent solid.

In addition, setting up the multiple fluent solid conveying compartments 200 has the following advantages:

1. Facilitating layered management: it may be possible to make each layer of the fluent solid conveying compartments 200 filled with the same kind of fluent solid, for example, medicines; and different layers of the fluent solid conveying compartments 200 are filled with different kinds of fluent solids, which may make the management of the fluent solids clear, and the filling is simpler and more convenient.

2. Convenient personalized combination: the number of layers of the fluent solid conveying compartments 200 can be selected according to the user's needs, for example, a single layer of the fluent solid conveying compartment 200 may be set up, and two or more layers of the fluent solid conveying compartments 200 may be set up.

3. Facilitating the expansion of the dose of the entire fluent solid dispensing system 100: the fluent solid conveying compartments 200 of different layers can be made to place the same kind of fluent solid, so as to realize the expansion of the dose of the fluent solid.

In use, the fluent solid in the chamber 45 of an upper layer of the fluent solid conveying compartment 200 may be funneled to the chamber 45 of a lower layer of the fluent solid conveying compartment 200 through the transferring port 161, thereby realizing the conveyance of the fluent solid between the multiple fluent solid conveying compartments 200 from top to bottom. A detachable stacking between two adjacent fluent solid conveying compartments 200 may be realized by means of snap-fit, magnetic connection, or the like.

In some embodiments, the fluent solid dispensing system 100 further includes a control compartment 600 and a drive mechanism 20. The control compartment 600 includes a second housing 80 and a control board 82 disposed in the second housing 80; the control compartment 600 is arranged in a removable stack with the fluent solid conveying compartment 200 that is at the outermost end in the stacking direction; the drive mechanism 20 includes a motor 21 and a transmission unit connected to an output shaft of the motor 21, the motor 21 being electrically connected to the control board 82, and the transmission unit being transmission-connected to the second enclosure 32.

The drive mechanism 20 is arranged in the first housing 10, and the motor 21 may be a stepping motor. The structure of the transmission unit may be various, such as a gear set, a transmission rod assembly, etc., as long as it can realize the transmission connection between the output shaft of the motor 21 and the second enclosure 32. In this way, the second enclosure 32 can be driven by the motor 21 to move relative to the first enclosure 31 to realize the control of different chambers 45 being in communication with the transferring port 161 to convey the fluent solid in the corresponding chamber 45 corresponding to the second enclosure 32. In a case of multiple fluent solid conveying compartments 200 stacked longitudinally, a control compartment 600 is detachably fixed to the uppermost fluent solid conveying compartment 200, which makes it more convenient to operate the fluent solid conveying compartments 200. The control board 82 within the control compartment 600 is configured to control the operation of the motor 21 to achieve precise control of the conveying of the fluent solid. The control compartment 600 and the fluent solid conveying compartment 200 may be detachably stacked by means of snap-fit, magnetic connection, or the like.

Further, the control compartment 600 further includes a battery 84; the second housing 80 defines a mounting cavity 81, the battery 84 is electrically connected to the control board 82, and the control board 82 and the battery 84 are both fixedly disposed in the mounting cavity 81. The battery 84 may be a dry battery or a storage battery, which is not specifically limited herein. The number of batteries 84 may be selected according to actual requirements. The battery 84 is configured to power the control board 82, the motor 21, and other electrical components.

Further, the control compartment 600 further includes a display panel 85 exposed to the second housing 80, and the display panel 85 is electrically connected to the control board 82. By providing the display panel 85, the dispensing status and operation steps of the fluent solid dispenser can be displayed to the user in real time to enhance the user experience. Specifically, the display panel 85 is arranged on a top wall of the second housing 80, such that the area of the display panel 85 can be set larger and more convenient for the user to observe.

Further, the control compartment 600 further includes multiple physical keys 86 arranged on a periphery of the display panel 85, and the control board 82 is arranged with key switches 83 corresponding to the physical keys. The physical keys 86 may be arranged on a top wall of the second housing 80 or a side wall of the second housing 80; or, some of the physical keys 86 may be arranged on the top wall, and some of the physical keys 86 may be arranged on the side wall of the second housing 80. The user may control the physical keys 86 to perform specific operations on the fluent solid dispensing system 100, which reduces the probability of key failure as compared to touch screen keys.

In some embodiments, the fluent solid dispensing system 100 further includes a collection compartment 500. The collection compartment 500 includes a third housing 70 and a drawer 72 movably connected to the third housing 70, an inner cavity of the drawer 72 being opened facing upward. The control compartment 600 and multiple fluent solid conveying compartments 200 are detachably stacked in an upward and downward direction on an upper end of the collection compartment 500. The control compartment 600 and the uppermost fluent solid conveying compartment 200 are detachably stacked, and the transferring port 161 of the fluent solid conveying compartment 200 adjacent to the collection compartment 500 is disposed above the drawer 72.

In the embodiments, the collection compartment 500 is combined with the fluent solid conveying compartments 200 to form a fluent solid transferring assembly 400. The inner cavity of the drawer 72 forms a collection tank 73 for collecting fluent solid. In use, the user operates an operation key of the chamber compartment 600 to effectuate the control of the conveying of fluent solid within a particular chamber 45 of the multiple fluent solid conveying compartments 200. During conveying, the fluent solid within the chamber 45 of an upper fluent solid conveying compartment 200 may leak through the transferring port 161 into the chamber 45 of a lower fluent solid conveying compartment 200, and the fluent solid that leak out of the transferring port 161 of the lowest fluent solid conveying compartment 200 flow into the drawer 72 of the collection compartment 500, thereby realizing the collection of the corresponding fluent solid. The user can take out the fluent solid by pulling the drawer 72, which is more convenient and hygienic to use.

Further, a bottom surface of the collection compartment 500 is concavely formed with a storage chamber 71, which may reduce the weight of the collection compartment 500 and make the entire fluent solid dispensing system 100 lighter. In addition, the storage chamber 71 may further be configured to receive a power adapter, a charger, and its connecting cables.

Finally, it should be noted that the above embodiments are only intended to illustrate the technical solutions of the present disclosure, and not to limit them. Although the present disclosure has been described in detail with reference to the foregoing embodiments, those skilled in the art should understand that it is still possible to make modifications to the technical solutions recorded in the foregoing embodiments, or to make equivalent replacements for some of the technical features therein. These modifications or substitutions do not cause the essence of the technical solutions to depart from the spirit and scope of the technical solutions of the embodiments in the present disclosure.

What is claimed is:

1. A fluent solid conveying assembly, comprising a first enclosure and a second enclosure;
wherein the first enclosure has a carrying surface, and the carrying surface defines an output port; the carrying surface and the second enclosure are enclosed to form a plurality of chambers that are mutually independent, and each of the plurality of chambers is configured to accommodate a fluent solid;
the second enclosure is movably connected to the first enclosure:
a) the second enclosure is restrictively mated with the first enclosure in a predetermined disassembly direction to follow the first enclosure to move in the disassembly direction; and
b) the second enclosure is movably arranged along the carrying surface; during a movement of the second enclosure along the carrying surface, each of the plurality of chambers is capable of being in communication with the output port.

2. The fluent solid conveying assembly according to claim 1, wherein the second enclosure comprises a spacer and a locking closure member fixedly connected to the spacer; the spacer is formed with a plurality of isolation grooves that are mutually independent, and the plurality of isolation grooves are mated with the carrying surface to form the plurality of chamber; the locking closure member is restrictively mated with the first enclosure in the disassembly direction, and the spacer is movable along the carrying surface.

3. The fluent solid conveying assembly according to claim 2, wherein the second enclosure is rotatably mated with the first enclosure around the disassembly direction, and the locking closure member is restrictively mated with the first enclosure in a radial direction.

4. The fluent solid conveying assembly according to claim 3, wherein the first enclosure is of a ring shape, and an inner edge of the first enclosure is disposed between the spacer and the locking closure member.

5. The fluent solid conveying assembly according to claim 4, wherein,
the locking closure member comprises a pressure plate and a retaining ring, the pressure plate being disposed opposite to the spacer, and the retaining ring being convexly disposed on a side of the pressure plate facing the spacer;
the first enclosure comprises an annular carrying plate, and the carrying surface is formed on the carrying plate; the carrying plate is sleeved on a periphery of the retaining ring, and an inner edge of the carrying plate is disposed between the pressure plate and the spacer;
the pressure plate is restrictively mated with the carrying plate in the disassembly direction, and the retaining ring is restrictively mated with the carrying plate in the radial direction.

6. The fluent solid conveying assembly according to claim 5, wherein the first enclosure further comprises an inner ring rib, and the inner ring rib protrudes on a side of the inner edge of the carrying plate away from the spacer; the inner ring rib is enclosed with the inner edge of the carrying plate to form a concave portion, an outer edge of the pressure plate is disposed at the concave portion, and the outer edge of the pressure plate is restrictively mated with the inner ring rib in the radial direction.

7. The fluent solid conveying assembly according to claim 6, wherein the first enclosure further comprises an outer ring rib, and the outer ring rib protrudes on a side of an outer edge of the carrying plate away from the spacer.

8. The fluent solid conveying assembly according to claim 7, wherein the first enclosure further comprises a plurality of connecting ribs, the plurality of connecting ribs being spaced apart along a peripheral direction of the inner ring rib and connecting the inner ring rib and the outer ring rib.

9. The fluent solid conveying assembly according to claim 3, wherein each chamber is opened on a side away from the first enclosure.

10. The fluent solid conveying assembly according to claim 2, wherein the spacer comprises an inner ring wall, an outer ring wall, and a plurality of scrapers; the outer ring wall is sleeved on a periphery of the inner ring wall, and the plurality of scrapers are spaced apart along a peripheral direction of the inner ring wall to separate an annular space between the inner ring wall and the outer ring wall to form the plurality of isolation grooves.

11. The fluent solid conveying assembly according to claim 10, wherein the spacer further comprises a connecting rib plate disposed on an inner peripheral surface of the inner ring wall, and the locking closure member is detachably fixed to the connecting rib plate.

12. The fluent solid conveying assembly according to claim 11, wherein the connecting rib plate is arranged with a thickened portion, and the thickened portion defines a fixing hole on a side of the thickened portion proximate to the locking closure member; the locking closure member defines an overhang facing the fixing hole, and the fluent solid conveying assembly further comprises a fastener that passes through the overhang and is detachably fixed to the fixing hole.

13. The fluent solid conveying assembly according to claim 10, wherein the first enclosure is of a ring shape, and an outer peripheral surface of the first enclosure is arranged in alignment with an outer peripheral surface of the outer ring wall.

14. A fluent solid conveying compartment, comprising a first housing and a fluent solid conveying assembly according to claim 1; the first housing defines a transferring cavity opened along the disassembly direction of the fluent solid conveying assembly, and a transferring port is defined on an inner wall of the transferring cavity facing the output port of the fluent solid conveying assembly; the fluent solid conveying assembly is detachably arranged the transferring cavity in the disassembly direction.

15. The fluent solid conveying compartment according to claim 14, wherein the first enclosure of the fluent solid conveying assembly is restrictively mated with the first housing along the carrying surface of the fluent solid conveying assembly.

16. The fluent solid conveying compartment according to claim 15, wherein the fluent solid conveying assembly is according to claim 3, and the first enclosure is restrictively mated with the first housing in a tangential direction around the disassembly direction.

17. The fluent solid conveying compartment according to claim 16, wherein a bottom wall of the transferring cavity is arranged with a plurality of limit keys, and the first enclosure defines keyways that are adapted to the plurality of limit keys.

18. A fluent solid dispensing system, comprising more than two the fluent solid conveying compartments each according to claim 14; wherein the more than two fluent solid conveying compartments are detachably stacked; in each two of the more than two fluent solid conveying compartments that are stacked adjacently, the transferring port of one of the two fluent solid conveying compartments is capable of being in communication with each chamber of the other of the two fluent solid conveying compartments and being aligned with the transferring port of the other of the two fluent solid conveying compartments.

19. The fluent solid dispensing system according to claim 18, further comprising a control compartment and a drive mechanism; wherein the control compartment comprises a second housing and a control board disposed in the second housing; the control compartment is arranged in a removable stack with one of the more than two fluent solid conveying compartments that is at an outermost end in a stacking direction; the drive mechanism comprises a motor and a transmission unit connected to an output shaft of the motor, the motor being electrically connected to the control board, and the transmission unit being transmission-connected to the second enclosure of each fluent solid conveying compartment.

20. The fluent solid dispensing system according to claim 19, further comprising a collection compartment; wherein the collection compartment comprises a third housing and a drawer movably connected to the third housing; an inner cavity of the drawer is opened facing upward; the control compartment and the at least two fluent solid conveying compartments are detachably stacked in an up-down direction on an upper end of the collection compartment; the control compartment and the fluent solid conveying compartment at the outermost end are detachably stacked, and the transferring port of one of the at least two fluent solid conveying compartments that is adjacent to the collection compartment is disposed above the drawer.
